(19) United States
(12) Patent Application Publication
(10) Pub. No.: US 2013/0218919 A1
(43) Pub. Date: Aug. 22, 2013

(54) Method and apparatus for managing content

(71) Applicant: Aleksey Solonchev, Torrance, CA (US)

(72) Inventor: Aleksey Solonchev, Torrance, CA (US)

(21) Appl. No.: 13/400,464

(22) Filed: Feb. 20, 2012

(51) Int. Cl. G06F 17/30

(52) U.S. Cl. 707/758; 707/E17.014

(57) ABSTRACT

A method and apparatus for managing content allowing construction of a content management system without providing a predetermined content schema or content type, whereby control objects provide data in property elements and a content query is constructed to select content fragments from a content repository. A content selection can be easily changed by changing a property of a control object without need for corresponding changes in other parts of the system. The system may span multiple web sites, services, or desktop applications, and can be implemented in a multitenant cloud based environment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The current invention relates generally to managing content for use with portals and other content delivery mechanisms and more particularly to processing content items in a content management system.

2. Description of the Related Art

Content management systems (CMS) allow publishing information on a web site. A typical web site includes multiple pages each containing multiple content items usually defined as field types, such as images, links, and blocks of text.

A CMS typically uses content schemas also known as content types to refer to a group of field types used on similarly looking web pages usually defined as page templates. Content types are used in a set of rules determining how the web site content is stored in a content repository and how it is displayed on web pages. Said set of rules defines relations between content types, field types and page templates.

However, in cases when there is need to perform significant changes in the page template, for example to add new or remove existing field type, this approach requires making changes in more than one place, for example changing page template, changing content type definition, and replacing a content type stored in content repository with the modified one. This makes the process time consuming, prone to errors, and requires a person who is skilled in management of the particular type of CMS.

To establish a list of actions that a particular user is allowed to perform on a particular page a set of user permissions is defined, usually grouped in a set of user groups stored in a directory service or a database. CMS defines a set of permission rules associating a particular set of permissions with a page template, web page or a group of pages. Such set of rules is stored in a content repository and used at runtime to allow or disallow a content management or viewing operation to a user.

Such approach creates rigid relationships between the web site, said permission rules, content types, field types and page templates. Such rigid relationships further complicate the process of making changes in the way the content is displayed on the web site, and also make it difficult to use CMS in multitenant cloud environment when one CMS must serve plurality of web sites owned by different tenants.

Also, binding field types to content types or content schemas makes it difficult to share portions of page content, for example a subset of field types, between multiple pages of the web site or between different web sites.

### SUMMARY OF THE INVENTION

It is an object of the present invention to provide a method and an apparatus for handling content in a content management system comprising a content repository configured to store a plurality of content elements, one or more page templates, wherein each said page template includes one or more control objects, a request builder, and an item selector configured to select a group of content elements from content repository.

### BRIEF DESCRIPTION OF THE DRAWINGS

FIG. 1 illustrates a computing environment and CMS, according to an example embodiment of the invention.

FIG. 2 illustrates an apparatus for managing content in an example embodiment of the invention.

FIG. 3 is a block diagram illustrating the handling of content data in an example embodiment of the invention.

FIG. 4 illustrates a method for managing content in an example embodiment of the invention.

FIG. 5 is a data diagram illustrating database fields and relationships in an example embodiment of the invention.

FIG. 6 is a block diagram illustrating objects and relationships in an example embodiment of the invention.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It will be apparent to those skilled in the art that the components portrayed can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for handling content in a content management system.

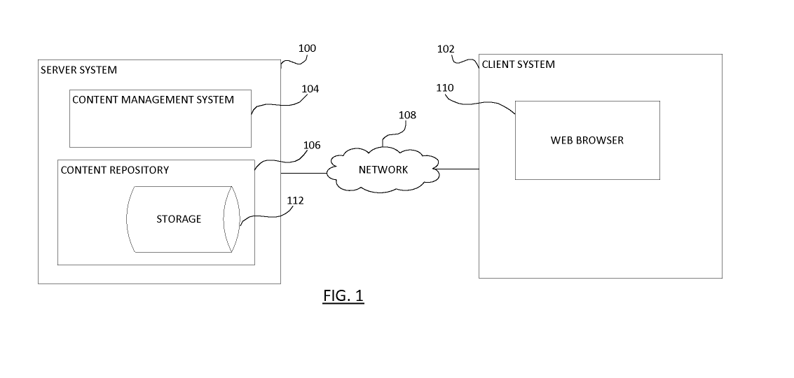

FIG. 1 is a block diagram that illustrates a client/server view of a computing environment, according to one embodiment of the invention. As shown, computing environment includes client computer system 102 communicating with a server system 100 over a network 108. The computer systems 100 and 102 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustration of computer systems 100 and 102 are simplified to highlight aspects of the present invention and that computing systems and networks typically include a variety of additional elements not shown in FIG. 1. Server system 100 may be connected to more than one client system. Additionally, server system 100 may be representative of systems built from one or more computer systems. For example, server system 100 may be represented by a server farm including plurality of web servers, database servers, application servers, network devices, and network connections. Network 108 represents any kind of data communications network, including both wired and wireless networks. Accordingly, network 108 is representative of both local and wide area networks, including the Internet. Additionally, those skilled in the art will recognize that the computer systems 100 and 102 may be represented by one or more software or hardware modules in a single computer system, communicating through internal network, software simulated network, or directly without a network connection.

As shown, client computer system 102 includes a web browser application 110 displays content received from server system 100. The web browser application 110 is included to be representative of existing applications or hardware implementations capable of displaying content and is not limited to any particular application or hardware implementation, or method of content encoding and transmission.

Illustratively, server system 100 includes a content management system (CMS) 104 and a content repository 106. In one embodiment, CMS 104 may be configured to provide services for managing content, including but not limited to services for creating and editing content, retrieving content from content repository 106, and saving content into content repository 106.

Illustratively, content repository 106 includes a data storage 112. The data storage 112 is included to be representative of existing storage systems, e.g., relational or non-relational databases, flat file databases, local or distributed file systems, spreadsheets, cloud based storage services, and may be based on any storage technology, such as RAID, NAS, SAN, or JBOD, may involve multiple storage nodes, including spanning multiple geographically separated sites, may consist of a service running on a computing resource that manages storage and archival media.

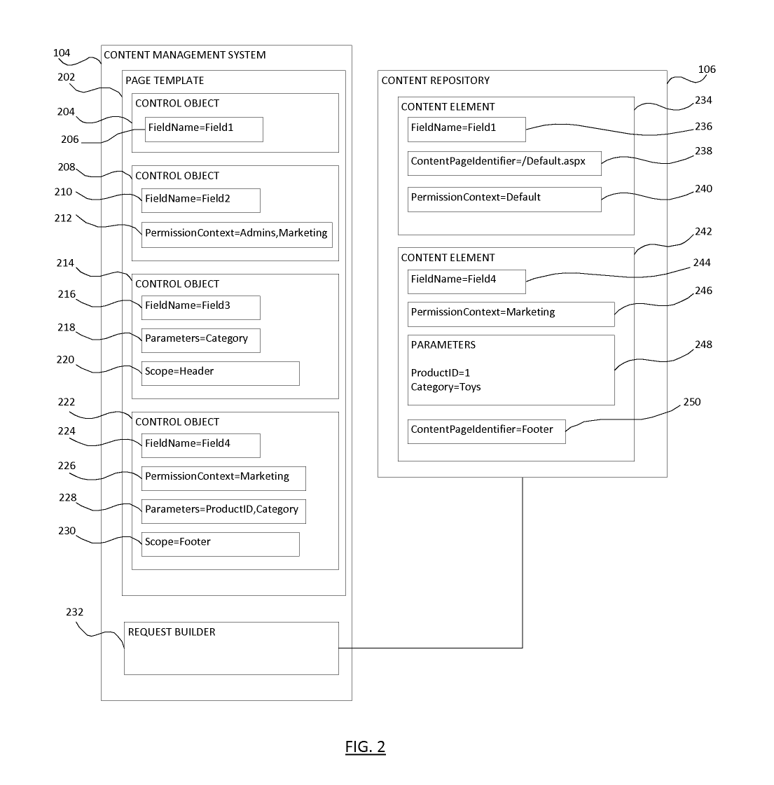

FIG. 2 illustrates an apparatus for managing content in an example embodiment of the invention.

CMS 104 includes one or more page templates 202 wherein each of such page templates 102 defining elements of layout of one or more content pages which eventually are displayed by the web browser application 110. The page template 202 is included to be representative of existing content rendering techniques typically involving a mixture of standard Hyper Text Markup Language (HTML) and a scripting language or combination of languages used for the dynamic creation of some portion of the Hyper Text Markup Language (HTML) web pages using syntax for a particular programming language or framework. Examples of different programming frameworks include: Java Server Pages (JSP), Active Server Pages (ASP), ASP.NET, Hypertext Preprocessor (PHP), etc. The programming frameworks are designed to allow programmers to develop dynamic content pages that may act as part of an application, including implementation of business logic and interactions with databases and other modules. Additionally, those skilled in the art will recognize that the page template 202 may involve a rendering technique based on other programming and markup languages and frameworks, such as XML, XSLT, XAML, Windows Forms, etc.

In one embodiment of the invention page template 202 is an ASP.NET page employing existing technique for content rendering wherein a file with .aspx extension provides a combination of HTML code and ASP.NET controls, and a file with .aspx.cs extension provides C# code for business logic and interactions with other components.

As shown in FIG. 2, in one embodiment of the invention there are control objects 204, 208,214, and 222 included in the page template 202 following known rules for particular type of the programming framework and language used for creating the page template 202. Each said control object logically corresponds to a user interface element and is responsible for performing a functionality of the user interface element and for displaying a content element. Those skilled in the art will recognize that the page template 202 may include zero or more said control objects, and that said control objects may be included in the page template 202 directly or indirectly through a hierarchy of parent elements. In one embodiment of the invention control objects 204, 208,214, and 222 are ASP.NET server-side controls compiled and collected into a server control class library within the server system 100.

As shown in FIG. 2, the control objects 204, 208,214, and 222 include property elements correspondingly 206, 210, 216, and 224 specifying a name value pair used in a query identifying content elements stored in the content repository 106. In one embodiment of the invention each property element 206, 210, 216, and 224 is a property of ASP.NET server-side control correspondingly 204, 208,214, and 222 wherein the property name is FieldName.

As shown in FIG. 2, the control objects 208, 222 include property elements correspondingly 212, 226 specifying a name value pair used in a query determining user permissions and permitted actions with respect to corresponding control object and corresponding content item. In one embodiment of the invention each property element 212, 226 is a property of ASP.NET server-side control correspondingly 208, 222 wherein the property name is PermissionContext.

As shown in FIG. 2, the control objects 214, 222 include property elements correspondingly 218, 228 specifying a list of parameter names. In one embodiment of the invention each property element 218, 228 is a property of ASP.NET server-side control correspondingly 214, 222 wherein the property name is Parameters. For example, property element 218 in the control object 214 specifies a list of parameter names containing single parameter name “Category”, and property element 228 in the control object 222 specifies a list of parameter names containing two parameter names: “ProductID” and “Category”, while control object 208 does not include a property element specifying a list of parameter names.

As shown in FIG. 2, the control objects 214, 222 include property elements correspondingly 220, 230 specifying a name value pair used in a query identifying content elements stored in the content repository 106. In one embodiment of the invention each property element 220, 230 is a property of ASP.NET server-side control correspondingly 214, 222 wherein the property name is Scope.

Those skilled in the art will recognize that the property elements 206, 210, 212, 216, 218, 220, 224, 226, 228, 230 are included to be representative of a technique of associating a name value pair with a control object following known rules for particular type of the programming framework and language used for creating the page template 202, and also that property names are specified here for illustrating purposes only and can be replaced with other property names allowed in the programming framework and language.

As shown in FIG. 2, the content management system 104 includes request builder 232 which collects property elements data, environment data, metadata, and request parameters, and sends collected information to content repository 106.

Content repository 106 contains zero or more content elements. Each content element represents a fragment of content, for example a text, picture, hyperlink, etc. Each content element has a metadata associated with it and is stored in the data storage 112. In one embodiment of the invention content repository 106 contains content elements 234, 242. Associated metadata is being represented by name value pairs correspondingly 236, 238, 240, and 244, 246, 248, 250. Those skilled in the art will recognize that the content elements and associated metadata may be stored in a number of data structures, including, for example, one or more database tables, flat lists, linked lists, trees, and the like.

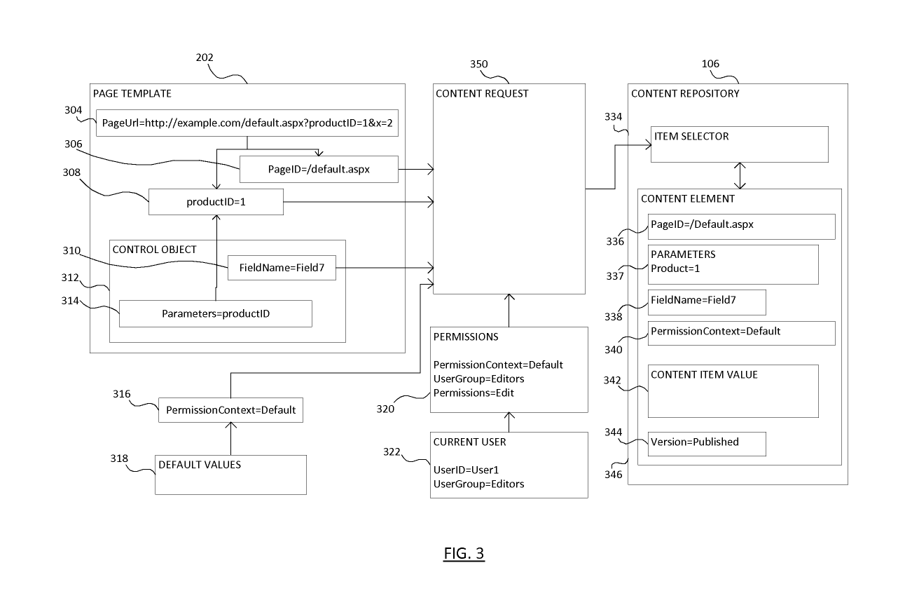

FIG. 3 is a block diagram illustrating the handling of content data in one embodiment of the invention.

A request property 304 is included to be representative of a content page identifier which uniquely identifies a content page among content pages served by the server system 100. In one embodiment of the invention the request property 304 is a uniform resource locator (URL), for example

http://example.com/default.aspx?productID=1&x=2

A page template identifier 306 is included to be representative of a page template identifier which uniquely identifies page template 202 among all page templates included in the CMS 104. In one embodiment of the invention the page template identifier 306 is a string calculated by the request builder 232 by eliminating such parts of the page URL like protocol, host, and query string, which for previous URL example would produce page template identifier value

/default.aspx

A control object 312 is similar to control objects 204, 208,214, and 222 and represents another example of property elements that may be included in a control object. In this example a property element 310 is similar to property elements 206, 210, 216, and 224 and has property name FieldName and value “Field?”. Also in this example a property element 314 in the control object 312 specifies a list of parameter names containing single parameter name: “productID”.

A parameter identifier 308 represents an example of a parameter name value pair used in a query identifying content elements stored in the content repository 106. In this example the name value pair has been calculated by extracting query string value “?productID=1&x=2” from the request property 304, matching query string parameters with the list of parameter names specified in the property element 314, and discarding non-matching parameters, which in this example produces name value pair “productID=1”.

A default values list 316 includes default values to be used instead of values specified in a property element in cases when a control object does not have said property element. As shown in FIG. 3 the control object 312 does not have a property element with name “PermissionContext”, that is why the value for corresponding name value pair is taken from the default values list 316. In this example the default values list 316 specifies value “Default” for a property name “PermissionContext”.

A security context module 322 retrieves current user identifier and a list of user groups with which this user is associated. Permissions module 320 includes permissions configuration data which allows calculating a set of permissions for specified user groups and available permission contexts.

The information collected by the request builder 232 is included in a content request 350 and the content request 350 is sent to an item selector 334 included in the content repository 106.

A content element 346 is similar to content elements 234, 242 and represents another example of metadata that may be associated with a content fragment stored in the data storage 112.

The content element 346 includes metadata element 336 to specify page template identifier value, metadata element 337 to specify parameters name value pairs, metadata element 338 to specify field name value, metadata element 340 to specify list of permission context names, content item value element 342 to store data describing a content fragment, and metadata element 344 to specify version of the content fragment.

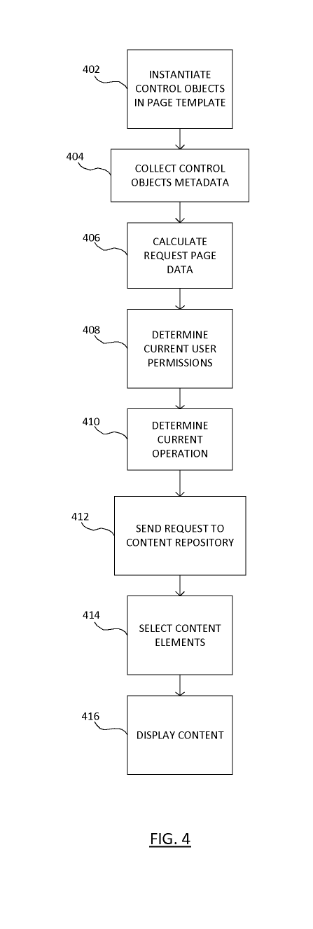

FIG. 4 illustrates method steps for managing content in an example embodiment of the invention.

At step 402 a page template is provided and one or more control objects are included into the page template and property elements of each control object are populated with values identifying:

a name of corresponding content element, e.g., FieldName=Field1;

a list of parameter names to be extracted from content page identifier, e.g., if a content page identifier is a URL and has value http://example.com/default.aspx?category=toys&productID=1&x=2, then a property element specified as Parameters=category,productID is used as an instruction to extract following two name value pairs from the content page identifier: category=toys,productID=1;

a list of permission context names providing reference to a set of permissions configured for different user groups, e.g., if a configuration file specifies that a user group “Editors” in a permission context “Marketing” has permissions “Edit” then a user assigned to the user group “Editors” will be granted permissions “Edit” for control objects having permission context name “Marketing” listed in said list of permission context names;

a scope identifier, which if provided extends the query selecting content elements from content repository, one example of such extension is: if a property element specifies Scope=Footer then the query disregards current page template identifier and uses value “Footer” in its place during selection of content elements;

other property elements that may modify user interface or behavior of the control object or modify query selecting content elements from content repository.

At step 404 a data including property elements data is collected from control objects included in the page template.

At step 406 a page request data is obtained, one example of such data is a data including page template identifier, content page URL, and web site identifier.

At step 408 a permissions data is collected, one example of such data is a data including current user identifier or name, a list of user groups to which the user is assigned, a permission configuration data specifying relationships between user groups, permission context names, and permissions or allowed actions.

At step 410 a content management operation is determined, examples of such operations may include: “Read published content”, “Read latest drafts”, “Check out”, “Save”, “Publish”.

At step 412 a request to perform the content management operation is built and sent to content repository. Examples of the request include an XML document, a URL-encoded list of data items, etc.

At step 414 a query is executed to select requested content elements. One example of such query is a SQL query selecting records from a relational database. In one embodiment of the invention a content element is selected when all of the following conditions are true:

there is a match between FieldName value submitted in the request and FieldName value found in corresponding metadata element associated with said content element;

there is a match between PageID value submitted in the request and PageID value found in corresponding metadata element associated with said content element and the Scope value is not provided by corresponding control object;

there is a match between parameters name value pairs submitted in the request and corresponding parameters name value pairs found in corresponding metadata element associated with said content element;

the content management operation determined at step 410 is allowed for the permission context found in corresponding metadata element associated with said content element according to the permissions data collected at step 408;

a version data found in corresponding metadata element associated with said content element is allowed for retrieval by the content management operation determined at step 410.

At step 416 a data including selected content elements and associated metadata is returned to requesting module and converted to a format that may be displayed to the user.

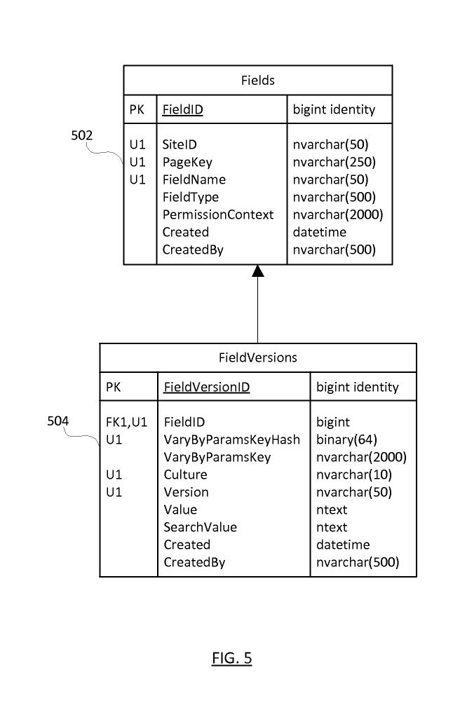

FIG. 5 is a data diagram illustrating one example of database fields and relationships used to store content elements in a data storage which includes relational database. In this example, the data is stored in two database tables Fields 502, and FieldVersions 504.

As shown in FIG. 5 the Fields table 502 has identity column FieldID and stores following metadata elements:

SiteID—an identifier which allows splitting the CMS in plurality of separate parts while re-using the same content page identifiers and FieldName values for different parts;

PageKey—holding content page identifiers;

FieldName—holding one of the values used in the query selecting content elements from the content repository;

FieldType—specifying type of user interface used to display content fragment;

PermissionContext—holding value used in a query determining user permissions and permitted actions;

Created—holding date and time when the content element was first created;

CreatedBy—holding user identifier of the user who created the content element.

As shown in FIG. 5 the FieldVersions table 504 has identity column FieldVersionID, references FieldID column from table 502, and stores following metadata elements:

VaryByParamsKey—holding parameters name value pairs in URL-encoded format;

VaryByParamsKeyHash—holding binary hash of the VaryByParamsKey value to allow case-sensitive search in a case-insensitive database;

Culture—holding a string describing a language of the content element in multilingual CMS and representing an example of additional metadata element used in the query selecting content elements;

Version—holding a string describing version of the content element as version number or identifier;

Value—holding a content fragment in a format determined by the FieldType metadata element;

SearchValue—holding the content fragment in a textual format facilitating text-based search for the content element;

Created—holding date and time when this version of the content element was first created;

CreatedBy—holding user identifier of the user who created this version of the content element.

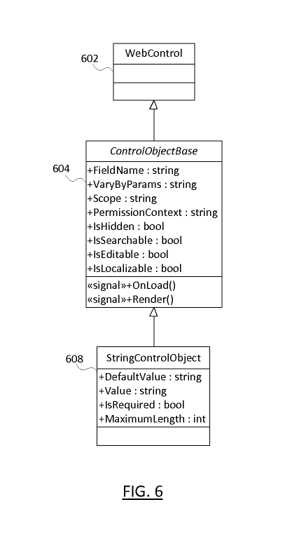

FIG. 6 is a block diagram illustrating control objects class hierarchy in an example embodiment of the invention, wherein class ControlObjectBase 404 inherits ASP.NET WebControl class 602. In this example StringControlObject class 608 represents a control object displaying simple text content element. StringControlObject class 608 extends class 604 with validation properties DefaultValue, IsRequired, and MaximumLength, and has string property Value that holds the content fragment.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for managing content, comprising:
providing a content repository capable of storing a plurality of content elements wherein each of said content elements includes a content fragment data and a metadata,
providing a page template,
including one or more control objects into said page template wherein each said control object includes a type identifier,
associating a group of property elements with each said control object,
collecting a page request data,
collecting a user permissions data,
collecting said type identifiers and said property elements from said control objects,
sending said page request data, said user permissions data, and said property elements to said content repository,
selecting a group of content elements from said content repository by matching said page request data, said user permissions data, and said property elements to said metadata using a predetermined set of rules,
returning said group of content elements to said page template.

2. The method of claim 1, wherein:
said group of property elements includes a field name property element;
said metadata includes field name metadata element;
said predetermined set of rules includes a first matching rule comparing said field name property element to said field name metadata element according to a first predetermined comparing algorithm.

3. The method of claim 2, wherein:
said page request data includes a page template identifier and may include a first group of page parameters containing zero or more said page parameters;
said group of property elements may include a parameters property element;
said metadata includes a template identifier metadata element and may include a parameters metadata element;
said predetermined set of rules includes a second matching rule comparing said page template identifier to said template identifier metadata element, and also may include a third matching rule comprising: selecting a second group of zero or more page parameters by comparing a name of each page parameter from said first group of page parameters to said parameters property element, and comparing said second group of page parameters to said parameters metadata element according to a second predetermined comparing algorithm.

4. The method of claim 3, wherein:
said metadata may include a permission context metadata element;
said group of property elements may include a permission context property element providing default value for corresponding said permission context metadata element;
collecting said user permissions data includes: retrieving a current user identifier,
providing a first list of user groups associated with said current user identifier wherein each of said user groups is associated with a corresponding list of group permissions,
providing a second list of available permission context names wherein each permission context name in said second list of available permission context names is associated with a corresponding list of user groups;

5. The method of claim 4, wherein:
said group of property elements may include a scope property element, and if said scope property element is included then said scope property element replaces said page template identifier in said second matching rule.

6. An apparatus for managing content, comprising:
a content repository configured to store a plurality of content elements wherein each of said content elements includes a content fragment data and a metadata,
one or more page templates, wherein each said page template includes one or more control objects, wherein each said control object includes a type identifier and also includes a group of property elements,
a request builder configured to collect a page request data, a user permissions data, said type identifiers and said property elements, wherein said request builder also configured to send said page request data, said user permissions data, said type identifiers and said property elements to said content repository,
an item selector configured to select a group of content elements from said content repository by matching said page request data, said user permissions data, and said property elements to said metadata using a predetermined set of rules, wherein said item selector is also configured to return said group of content elements to said page template.

7. The apparatus of claim 6, wherein:
said group of property elements includes a field name property element;
said metadata includes field name metadata element;
said predetermined set of rules includes a first matching rule configured to compare said field name property element to said field name metadata element according to a first predetermined comparing algorithm.

8. The apparatus of claim 7, wherein:
said page request data includes a page template identifier and may include a first group of page parameters containing zero or more said page parameters;
said group of property elements may include a parameters property element;
said metadata includes a template identifier metadata element and may include a parameters metadata element;
said predetermined set of rules includes a second matching rule comparing said page template identifier to said template identifier metadata element, and also may include a third matching rule configured to select a second group of zero or more page parameters by comparing a name of each page parameter from said first group of page parameters to said parameters property element, and to compare said second group of page parameters to said parameters metadata element according to a second predetermined comparing algorithm.

9. The apparatus of claim 8, wherein:
said metadata may include a permission context metadata element;
said group of property elements may include a permission context property element providing default value for corresponding said permission context metadata element;
said user permissions data includes a current user identifier, a first list of user groups associated with said current user identifier wherein each of said user groups is associated with a corresponding list of group permissions, a second list of available permission context names wherein each permission context name in said second list of available permission context names is associated with a corresponding list of user groups.

10. The apparatus of claim 9, wherein:
said group of property elements may include a scope property element, and if said scope property element is included then said scope property element replaces said page template identifier in said second matching rule.
